(19) United States
(12) Patent Application Publication
(10) Pub. No.: US 2026/0096582 A1
(43) Pub. Date: Apr. 9, 2026

(54) Edible Products Derived from Insect Protein, and Processes for Making Same

(71) Applicant: Board of Supervisors of Louisiana State University and Agricultural and Mechanical College, Baton Rouge, LA (US)

(72) Inventors: Elio Villasmil Gonzalez, Baton Rouge, LA (US); Witoon Prinyawiwatkul, Baton Rouge, LA (US)

(73) Assignee: Board of Supervisors of Louisiana State University and Agricultural and Mechanical College, Baton Rouge, LA (US)

(21) Appl. No.: 19/346,752

(22) Filed: Oct. 1, 2025

Related U.S. Application Data
(60) Provisional application No. 63/702,680, filed on Oct. 3, 2024.

(51) Int. Cl. A23L 27/21; A23J 3/04; A23J 3/32; A23L 5/20; A23L 27/50; A23L 29/30

(52) U.S. Cl. CPC A23L 27/215; A23J 3/04; A23J 3/32; A23L 5/20; A23L 27/50; A23L 29/30

(57) ABSTRACT

A process and product obtainable by acid hydrolysis of insects, for example from cricket powder. As one application, an acid hydrolysis product made from powdered crickets may be used as a seasoning sauce resembling soy sauce. The insect powder is hydrolyzed with acid, followed by neutralization, and optionally clarification. In comparison to the typical production of soy sauce, the acid hydrolysis procedure uses insect protein as the main substrate or even the sole substrate. The flavor of soy sauce-like products made from acid-hydrolyzed cricket protein results from a complex combination of compounds generated by the reactions.

The benefit of the Oct. 3, 2024 filing date of U.S. provisional patent application Ser. No. 63/702,680 is claimed under 35 U.S.C. § 119 (e).

### TECHNICAL FIELD

This invention pertains to edible products derived from insect protein, and processes for making such edible compositions.

### BACKGROUND ART

Edible insects are a potential new sustainable food source. Studies have found that species such as house crickets (Acheta domesticus), yellow mealworm (Tenebrio molitor), silk moth larvae (Bombyx mori), and mopane worm larvae (Gonimbrasia belina L) are superior to meat from slaughtered livestock in terms of protein, essential amino acids (EAA), polyunsaturated fatty acids, some vitamins (e.g., tocopherol and riboflavin), and minerals (calcium, zinc, copper, and manganese). Edible insects have similar caloric content to meat on an equal-weight basis. Insects are a good source of chitin, fiber, and vitamin C. Many nutrients found in edible insects are associated with health benefits for gastrointestinal, cardiovascular, and other conditions.

Another benefit of edible insects is the reduced environmental impact. Edible insect farming can help mitigate ecological problems caused by traditional meat and food production processes, such as wastewater, terrestrial and aquatic ecotoxicity, land use, and greenhouse gas emissions.

A major constraint on the use of insects as a food source is low acceptability among consumers in western societies. There is an unfilled need for new processes to enhance the sensory quality and acceptability of insect-based products, for example by generating new flavors.

Entomophagy, the eating of insects, is widespread in many parts of the world. More than 2,000 species of insect are consumed, mostly in Asia, Australia, Africa, and Central and South America. However, in Western societies the consumption of insects faces significant constraints due to low sensory appeal and unfamiliarity.

Enhancing the flavor of insect-derived products might increase their acceptability as food. Many factors influence the sensory characteristics of edible insects, including species, stage of maturation, method of killing, preservation, processing, and preparatory treatments such as defatting, chitin removal, and protein concentration or isolation. The sensory profile of edible insects could potentially be further improved by further processing steps such as enzymatic hydrolysis or fermentation. For example, enzymatic treatment of cricket (Acheta domesticus) and mealworm (Tenebrio molitor) proteins has resulted in the formation of aroma compounds described as mushroom-like and meaty. Fermentation with lactic acid bacteria has been reported to decrease unfavorable aroma compounds from Allomyrina dichotoma larvae, improving their overall flavor.

Most prior studies in this area have focused on the simple addition of edible powdered insects to foods, but usually without additional treatments intended to induce the formation of new flavoring components to the insect-derived products. Edible insects contain numerous precursors to volatile or non-volatile compounds that can contribute to aromatic profiles that could potentially imitate or even improve on those present in meat or bakery products.

The formation of flavor- and taste-active compounds in insects depends primarily on proteins and lipids. These compounds are generated from complex reactions that depend on the composition, characteristics, and availability of macronutrients in the matrix. Amino acids play a role as flavor agents in their own right, as well as precursors to other flavor agents. Proteins can bind flavor agents due to their structural complexity. The role of lipids should also be considered since they can serve as carriers for liposoluble flavor compounds, but lipids can also be prone to oxidation.

The conventional processing of edible insects includes pretreatment steps; inactivation steps; extraction of one or more nutrients such as proteins, fat, or chitin by physical, chemical, or biochemical techniques; drying by convection oven, microwave drying, lyophilization, sun drying, or vacuum drying; and packaging and storage.

One of the most common pretreatment steps in the edible insect industry is blanching. Blanching inactivates many potentially deteriorative enzymes by soaking the substrate in hot water for a short time.

As part of the processing, a lipid fraction is often separated from the proteins and carbohydrates in insect meals through methods such as Soxhlet, solvent extraction, simultaneous distillation, steam distillation, or roto evaporation under vacuum conditions.

The extraction of chitin, unlike protein or fat isolation, is usually intended primarily for generating a usable biomaterial. However, chitin itself can also be used as a substrate to produce primary or secondary metabolites that can modify flavors.

Drying is generally employed prior to packaging and storage. Conventional methods of drying involve spray drying, oven-drying, roasting, or sun-drying; and other techniques include freeze-drying, microwave-assisted drying, infrared drying, or high-frequency drying. The drying step can alter aroma and flavor, particularly when heating is used.

The processing steps used for the inactivation of enzymes, reduction of particle size, reduction of water activity, extension of shelf life, or the concentration/isolation of one or more nutrients can also influence the flavor profile of insect products. These changes can be incidental, or they can be used to advantage to enhance the flavor profile of insect meal.

Enzymatic proteolysis has been used on various vegetable- and animal-based substrates to improve the digestibility of proteins, functional properties, and the availability of bioactive components. Enzymatic proteolysis can also influence flavor composition, since some amino acids and small peptides are released by enzymatic cleavage of peptides bonds in proteins. The enzymes most commonly used in processing edible insects are endoproteases from Bacillus licheniformis or B. amyloliquefaciens, endo- and exoproteases from A. oryzae, and in some cases papain and bromelain, especially when the removal of chitin is desired. Something that has frequently been overlooked is the effect of enzymolysis on the flavor profiles of small peptides, oligopeptides, and organic acids.

Acid hydrolysis can release small molecules such as amino acids, peptides, and monosaccharides from more complex structures such as polysaccharides and proteins. Acid hydrolysis has been used for the quantification of amino acids, for saccharification, for recovery of flavor compounds from lignocellulosic materials, modification of functional properties of insoluble proteins and starches, and production of flavor agents from vegetable proteins such as pea, wheat, maize, and soy. The production of flavor agents from acid hydrolysis results not only from the liberation of amino acids having a characteristic taste profile, but also from the formation of other flavor compounds through Maillard reaction mechanisms when a substrate is heated in the presence of reducing sugars. Acid hydrolysis has been used in the production of hydrolyzed vegetable proteins (HVP), for example with soy, corn, wheat, rice, and even whey proteins.

Fermentation has been used to enhance the taste profile and nutritional value of insect products by the formation of pleasantly-flavored compounds and nutrients.

There has been at least one fermentation process using cricket-derived protein to produce a seasoning sauce similar in taste to soy sauce. This process is time-consuming, complex, and costly. It requires a long-duration fermentation (evidently, several months), and appears also to require the addition of other ingredients. This extended time frame not only increases production costs due to longer holding times, but also requires careful monitoring to maintain optimal fermentation conditions. Moreover, to achieve the desired flavor complex in the final seasoning, other ingredients such as sugars, salts, and flavor enhancers (e.g., rice or wheat) are added during, after, or before the fermentation. See Ben K, “Put a spring in your sushi with cricket soy sauce from Antcicada,” Japan Today (Nov. 7, 2020).

M. Dhakal et al., “Physiochemical characteristics, volatile compounds and bioactivities of fermented seasoning sauce produced from cricket (Acheta domesticus), Future Foods 11 (2025) 100505 describes a process for making a seasoning sauce from house cricket meal using enzymatic digestion and bacterial fermentation. The resulting sauce was said to be similar to, although distinct from, Thai fish sauces.

K. Grossmann et al., “New insights into the flavoring potential of cricket (Acheta domesticus) and mealworm (Tenebrio molitor) protein hydrolysates and their Maillard products,” Food Chemistry 364 (2021) 130336 describes a process for modifying flavor profiles of preparations made from cricket or mealworm by enzymatic hydrolysis and Maillard reaction with added xylose.

See also S. Yoon et al., “Comparative characterization of protein hydrolysates from three edible insects: mealworm larvae, adult crickets, and silkworm pupae,” Foods 8 (2019) 563; Z. Ma, “Current state of insect proteins: extraction technologies, bioactive peptides and allergenicity of edible insect proteins,” Food & Function 14 (2023) 8129; H. Lisboa et al., “Harnessing insects as novel food ingredients: nutritional, functional, and processing perspectives,” Insects 16 (2025) 783; and M. Mishyna et al., “Techno-functional properties of edible insect proteins and effects of processing,” Current Opinion in Colloid & Interface Science 56 (2021) 101508.

E. Villasmil et al., “Induction of Aroma Compounds in Cricket (Acheta domesticus) Protein through Controlled Maillard Reaction” (Abstract, IFT First Expo, Jun. 13, 2023); and E. Villasmil et al., “Induction of Aroma Compounds in Cricket (Acheta domesticus) Protein through Maillard Reaction” (Slide Show, IFT First Expo, Jun. 13, 2023) reported work by the inventors and colleagues on compounds generated through the Maillard reaction on cricket powder.

No prior studies are known investigating the effect of acid hydrolysis on insect proteins as a potential food source, particularly the effects on volatiles, organic acids, and other flavor-related compounds.

### DISCLOSURE OF THE INVENTION

We have discovered a novel process and product obtainable by acid hydrolysis of insects, for example acid hydrolysis of cricket powder. As one application, an acid hydrolysis product made from insect protein may be used in a seasoning sauce resembling soy sauce. The insect product (e.g., cricket powder) is hydrolyzed with acid (e.g. 1-6 N HCl) with subsequent neutralization (e.g., with sodium hydroxide), and optional clarification (e.g., centrifugation, filtration, or both). In comparison to the typical production of soy sauce, the novel acid hydrolysis procedure uses insect protein (e.g., cricket powder) as the main or even the sole substrate.

A preferred embodiment comprises heating a cricket protein and acid mixture just below boiling (e.g., at 95-100° C.) with reflux for about 8 h. This process releases (or generates) large concentrations of amino acids and other flavoring agents in a short period of time (e.g., several hours, as compared to about 6-8 months for a traditional soy sauce fermentation), at a lower cost. The resulting liquid hydrolysate contains more total amino acids than traditional soy sauces. Organic acids contributing to flavor are also found in the hydrolysate, for example succinic acid or lactic acid. The cricket seasoning sauce possesses an aromatic profile resembling that of commercial soy sauces, with sensory notes identified by consumers (based on 130 consumer panelists) such as soy sauce-like, savory, seasoning-like, smoky, salty, meat-like, pungent, roasted, and umami.

The seasoning sauce can enhance the palatability of various foods and food products. It can be applied directly to foods, or it may be used as an ingredient in cooking. Based on its protein content and amino acid composition, it may be further concentrated and used as a high protein-shot beverage or as a nutritional supplement, or it may be further dried to a powder form.

In initial embodiments, cricket protein powder was used as the starting material. Other edible insects may be used as alternative substrates.

### MODES FOR CARRYING OUT THE INVENTION

### Example 1. Materials and Methods

House cricket (Acheta domesticus) powder was purchased from Thailand Unique (JR Unique Food Ltd., Thailand). The powder was packed in an airtight bag and held in a refrigerator at 4° C. until used. Hydrochloric acid and sodium hydroxide (37%) ACS reagent grade were purchased from LAB Alley (Spicewood, Texas, USA). Volatiles standard solutions such as EPA 166 8270 Semi volatile Internal Standard Mix; 2-Heptanone, 1-(2-furanyl)-ethanone; 2,5-dimethylpyrazine; Benzaldehyde; 5-methyl-2-Furancarboxaldehyde; 2-Acetyl-5-methylfuran; Phenylacetaldehyde; 2-methyl-Phenol; Acetophenone; 2-methoxy-Phenol; Nonanal; 1-(5-methyl-2-furanyl)-1-Propanone; dihydro-5-pentyl-2 (3H)-Furanone; and organic acids such as Oxalic acid, formic acid, lactic acid, acetic acid, orotic acid, succinic acid, uric acid, fumaric acid, propionic acid, and butyric acid analytical standards were purchased from Sigma-Aldrich (St. Louis, Missouri, USA), from Ambeed, Inc. (Arlington Heights, Illinois, USA), or from Supelco (Bellefonte, Pennsylvania, USA).

### Example 2. Acid Hydrolysis of Cricket Powder from Acheta domesticus at Different Ratios and Concentrations of Mineral Acid

Dried cricket powder was mixed with hydrochloric acid (6 N; 3 N; or 1 N) at different volumetric ratios of cricket powder to acid: 1:10, 1:5, and 1:3. The temperature of the reaction was 95±2° C. for 8 h. Hydrolysis was conducted in a reflux apparatus with cold water (<4° C.) recirculation through the condenser. After completing the reaction time, the samples were cooled to room temperature and then neutralized with sodium hydroxide (6 N; 3 N; or 1 N) to pH 4.5. After neutralization, the samples were centrifuged at 5000 rpm and filtered through 0.45 μm Whatman filters. After filtration, the hydrolysates were stored under refrigeration (4° C.) until used or analyzed.

### Example 3. Composition Analysis

Total solids content was calculated by determining moisture content using the AOAC Official Method 935.29 (AOAC, 2013). Ten grams of sample were dried in a convection oven at 105° C. for 24 h until reaching a constant weight. Ash content was determined using AOAC Official Method 920.153 (AOAC, 1920) on dried hydrolysate samples. Total lipids content was determined by Soxhlet extraction method on dry hydrolysate samples with hexane.

### Example 4. Determination of Total and Reducing Sugars

Total sugar content was determined by the phenol-sulfuric acid method. Reducing sugars were quantified with Dinitrosalicylic acid (DNS). The DNS reagent was prepared by combining 1% (w/v) DNS, 2% (w/v) NaOH, and 20% (w/v) sodium potassium tartrate. For analysis, 1 ml of the cricket hydrolysate sample was mixed with 1.5 mL of DNS reagent, and then submerged in a boiling water bath for 10 minutes. After cooling, optical absorbance was measured at 540 nm. Quantification used a glucose standard curve. 201

### Example 5. Color

Color parameters were determined by measuring CIE Lab values on hydrolysates using a Colorimeter BC-10 Baking Contrast Meter, Konica Minolta (Konica Minolta, Sensing Americas, Ramsey, NJ, U.S.A). Ten milliliters of sample were placed in a petri dish, assuring that the lens of colorimeter was covered by the hydrolysate. The three-dimensional color space allowed for objective, instrumental comparisons of light/dark (L*), green/red (−/+a*), and blue/yellow (−/+b*) across samples. Color measurements were performed in triplicate.

### Example 6. Viscosity

The viscosity of the hydrolyzed cricket protein samples was measured using a rotational viscometer (ROTAVISC lo-vi Complete, IKA-Werke, Staufen, Germany). The measurements were conducted at 25° C. in a 10 mL probe chamber equipped with a jacket connected to a water chiller for precise temperature control.

### Example 7. Salt Content

The salt content (expressed as sodium chloride, g/100 mL) was determined by titration with AgNO₃ using the Mohr method.

### Example 8. Free Amino Acids Determination

Free amino acids were determined with a Dionex Ultimate-3000 system (Thermo Scientific Dionex Ultimate 3000; MA, USA), including a Dionex Ultimate 3000 Pump, Ultimate 3000 Autosampler, Ultimate 3000 Column Compartment, and Ultimate 3000 Photodiode Detector. The sample was separated using a Waters Pico-Tag C18 column (4 μm, 3.9×150 mm) with Nova-Pak guard column (4 μm, 3.9×20 mm) maintained at 39° C. The mobile phase comprised eluent A (140 mM sodium acetate, 0.05% triethylamine, titrated to pH 6.40 with glacial acetic acid with the addition of 60 ml/L acetonitrile), and eluent B (60% acetonitrile in water). The detection wavelength was 254 nm. The injection volume was 20 μl. An aliquot of 100 μL was diluted into 10 ml 0.1% HCl, and centrifuged at 4000 rpm for 5 min. A clear liquid was obtained after filtering with a 0.2 μm syringe filter. Then 200 μl of sample and 20 μl Norleucine (2.5 μmol/ml) were mixed in a 2 ml Eppendorf vial and freeze-dried. Then 100 μl PITC solution (EtOH:water:PITC:triethylamine=7:1:1:1) was added and mixed for 30 min, followed by freeze-drying. The freeze-dried matter was dissolved into 1 mL buffer solution (Eluent A), filtered with a 0.2 μm syringe filter, and then used as an injection sample.

### Example 9. Efficacy of Amino Acid Recovery from Cricket Protein Via Acid Hydrolysis

The efficacy of AA recovery was calculated based on the original amount of AA in the cricket protein, versus the AA quantified in each hydrolysate after neutralization, centrifugation, and filtration. The recovered AA thus excluded fractions that partitioned with insoluble portions of the hydrolysates.

### Example 10. Organic acid determination by RP-HPLC

Quantitative analysis of organic acids was performed by RP-HPLC. Five hundred microliters of sample were mixed with 10 μL of maleic acid (as an internal standard), and diluted with water to obtain a 10 mL sample. Subsequently the samples were filtered through PDVF membranes (0.45 μm) prior to HPLC analysis. Separation was performed on an Atlantis™ dC18 5 μm (4.6×250 mm) column (Waters, Ireland). A phosphate buffer solution was prepared with sodium phosphate at 20 mM, adjusted to pH 2.10 with phosphoric acid. An isocratic solvent program was used. Solvent contained 1% acetonitrile in phosphate buffer. The flow rate was 1.5 ml/min. All solutions, solvent, and samples were filtered through 0.45 μm PDVF membranes. The injection volume was 10 pl. Calibration curves were prepared for each compound at 5 different concentrations, adding maleic acid as an internal standard.

### Example 11. Volatiles Profile Determination by GC-MS

Volatiles compositions were obtained by headspace solid phase microextraction (HS-SPME). Samples were diluted in deionized water (0.5 ml of sample in 9.5 ml of water). Three grams of NaCl were added to the samples, which were transferred into 20-mL vials with metal caps and PTFE/silicone septa. For solid-phase microextraction, samples were incubated in an agitator at 65° C. for 30 min, and extracted for 20 min using a PDMS/DVB arrow fiber (Agilent Technologies, Waldbronn, Germany). Desorption was carried out with an SSL injector operated 264 in a splitless mode at 2 mL/min for 2 min. A GC system 8890 (Agilent Technologies, Waldbronn, Germany) was used with a HP-5MS UI (30 m×250 μm×0.25 μm) column (Agilent Technologies, Waldbronn, Germany) with a helium flow rate of 1.07 mL/min. The system was held at 270° C. Mass spectrometry detection was performed with mass spectrometer MSD 5977 (Agilent Technologies, Waldbronn, Germany). All compounds were identified by their mass spectra as compared with the NIST library, and semi-quantified by relative area as compared with an EPA 8270 Semi volatile Internal Standard Mix (Sigma Aldrich). Compounds of interest, as previously identified in preliminary studies, were quantified by comparing their ion peaks with those of standards. Calibration curves for each compound were based on plotting points at five different concentrations.

### Example 12. Statistical Analysis

Each experiment was performed in triplicate. All data were statistically evaluated using SAS software version 9.4 (SAS Institute Inc., Cary, NC, U.S.A) and Microsoft Excel. Data were evaluated by analysis of variance (ANOVA) following the post-hoc Tukey's test to compare means with significant differences (p<0.05). A bivariate correlation analysis was conducted to assess the relationships between ratio, concentration, each of the response variables, volatile compounds, and organic acids. The Pearson correlation coefficient was used to determine the strength and direction of the linear relationships.

### Results and Discussion

### Example 13. Composition Analysis

The composition of Acheta domesticus hydrolysates is summarized in Table 1. The total solid content of hydrolysates increased significantly both with increasing CP:Acid ratios, and with higher concentrations of HCl. Ash content showed a similar correlation. Since one use of the hydrolysate is as a flavoring agent, the composition can be compared with analyses from the literature for other types of sauces, for example soy sauce. Soy sauce can have total solids between 20 wt % and 50 wt %.

TABLE 1
Composition of cricket powder hydrolysates.

| | | | | | Total Amino |
|---|---|---|---|---|---|
| CP:A | Acid | Total Solids | Lipids | | acid content |
| Ratio | Concentration | (g/100 g) | (g/100 g) | Ash (g/100 g) | (g/100 g) |
| 1:10 | 1N | 5.76 ± 0.72^{Bc} | 0.26 ± 0.03^{Bb} | 2.53 ± 0.08^{Bc} | 0.74 ± 0.18^{Ab} |
| 1:5 | | 8.25 ± 0.51^{Ab} | 0.66 ± 0.10^{Ac} | 3.00 ± 0.22^{Ac} | 0.90 ± 0.19^{Ac} |
| 1:3 | | 9.69 ± 0.91^{Ac} | 0.67 ± 0.05^{Ab} | 3.06 ± 0.20^{Ac} | 0.91 ± 0.14^{Ac} |
| 1:10 | 3N | 11.03 ± 0.96^{Bb} | 1.42 ± 0.11^{ABa} | 7.13 ± 0.03^{Bb} | 1.19 ± 0.20^{Cb} |
| 1:5 | | 12.69 ± 0.39^{Ba} | 1.32 ± 0.11^{Bb} | 7.20 ± 0.17^{Bb} | 2.40 ± 0.42^{Bb} |
| 1:3 | | 17.69 ± 0.95^{Ab} | 1.77 ± 0.24^{Aa} | 7.73 ± 0.33^{Ab} | 4.27 ± 0.54^{Ab} |
| 1:10 | 6N | 16.10 ± 0.95^{Ba} | 1.23 ± 0.05^{Ca} | 12.21 ± 0.04^{Ba} | 2.53 ± 0.78^{Ca} |
| 1:5 | | 19.17 ± 0.33^{Aa} | 1.58 ± 0.10^{Ba} | 13.75 ± 0.25^{Aa} | 4.91 ± 0.76^{Ba} |
| 1:3 | | 21.44 ± 1.09^{Aa} | 1.94 ± 0.06^{Aa} | 13.18 ± 0.41^{Aa} | 6.90 ± 1.06^{Aa} |

Data represent means of triplicates. Total amino acid content is the sum of that for 17 individual AAs. Different upper-case superscript letters denote significant differences (p < 0.05) between ratios (1:10, 1:5, and 1:3) at the same acid concentration. Different lower-case superscript letters denote significant differences (p < 0.05) between acid concentration (1N, 3N, and 6N) at the same CP:A ratio.

These observations indicated that total solids concentration increased significantly with the acid concentration, and also with an increasing CP:A ratio. The highest value, 21.44+1.09 g/100 304 g, was seen in samples with 1:3 of CP:A and 6 N; and the lowest value, 5.76+0.72 g/100 g, was seen at a ratio 1:10 and 1 N.

Note that commercial products can incorporate various additives, depending on brand, type, and origin. Commercial soy sauce can for example include additives such as cane or palm sugar, aspartame, acesulfame potassium, acetic acid, citric acid, monosodium glutamate, disodium guanylate, disodium inosinate, caramel, sodium benzoate, sulphite, or xanthan gum. Such additives can of course affect measurements of components in commercial products.

When evaluating lipid content of the hydrolysates, one should keep in mind that no defatting step was performed with the cricket protein prior to hydrolysis in this prototype embodiment. (Optionally, the lipid fraction could be wholly or partially depleted prior to hydrolysis, but such depletion was not carried out for the prototype embodiment.) The lipid content showed no significant variation between hydrolysis with HCl at 3 N and 6 N; however, the lipid content decreased when hydrolysis was conducted with 1 N, perhaps because the solid residues before centrifugation were larger in size, suggesting incomplete disruption of macromolecules and removal of lipid content during the filtration steps. Literature reports that the lipid content of soy sauce and similar seasonings ranges from about 0.44 to about 0.66 g per 100 g. In the present study, the fat content varied from 0.26 to 1.94 g per 100 g hydrolysate; and it increased with increasing acid concentration during hydrolysis; and also with increasing ratio of CP:A, except for samples treated with 1 N. For the fat content from the higher CP:A ratios, 1:5 and 1:3, note that even though these are common proportions for wheat/soy meals and acid in commercial soy sauces, there were no defatting steps prior to the hydrolysis in our prototype embodiment. The ash content varied with the acid concentration, with the lowest value of 2.53±0.08 g per 100 g at a 1:10 ratio and 1 N HCl; and the two highest values of 13.75±0.25 g per 100 g at a 1:5 ratio and 6 N HCl, and 13.18±0.41 g per 100 g at a 1:3 concentration and 6 N HCl. These results suggest that the mineral content came primarily from NaCl formed during the neutralization of HCl with NaOH, since the amount of ash present in cricket protein powder does not exceed 5% in most cases, and the amount of cricket powder used was no more than 33% w/v. The total amino acid content in the hydrolysates increased gradually with the addition of CP. At the lowest concentrations of HCl used there was no significant variation in AA concentration among the ratios, while for 3 N and 6 N the concentration of AAs increased proportionately with the amount of CP used.

### Examples 14 and 15. Determination of Total and Reducing Sugars and Color Formation

Acid hydrolysis of cricket powder involves the cleavage of glycosidic linkages of chitin into monomeric units in three steps: depolymerization into smaller molecules, generation of N-acetylglucosamine (GlcNAc), and deacetylation of N-acetylglucosamine into 2-amino-2-deoxy-D-glucose (Glucosamine, GlcN). Both of these water-soluble monomers contribute to the measured total sugar content and reducing sugar content, since GlcN possesses free anomeric carbon. As a result, the content of total and reducing sugars in the solution is expected to increase post-hydrolysis. However, total and reducing sugars both increased with increased CP:A ratio in hydrolysis, while higher HCl concentrations resulted in lower reducing sugar content, due to the degradation of the sugars at higher acid concentrations. (Data not shown, but provided in priority application 63/702,680.)

The variations in reducing sugar content showed a similar trend at the three acid concentrations tested. At 1 N HCl, there was a steady increase in reducing sugar content as the CP:A ratio increased, with values of 1.87 mg/mL, 3.13 mg/mL, and 4.46 mg/mL for ratios of 1:10, 1:5, and 1:3, respectively. At 3 N HCl, a similar trend was seen with 1.49 mg/mL, 2.78 mg/mL, and 3.87 mg/mL for the same CP:A ratios. At 6 N HCl the reducing sugar content was significantly lower as compared to other acid concentrations, with values of 0.50, 1.05, and 2.02 mg/mL for the same respective ratios. Similar trends for both parameters, CP:A ratio and acid concentration, were observed for total sugar content, with an increased ratio leading to a higher total sugar content, and higher HCl concentrations resulting in lower total sugar content. The observed decrease in total and reducing sugars in the hydrolysates with increasing acid concentration could be due to the instability of GlcN, and the occurrence of Maillard reaction with peptides and amino acids. GlcN is relatively unstable, with a high level of degradation products even at temperatures as low as 37° C. The degradation leads to the formation of dicarbonyl compounds, precursors to the Maillard reaction, involving the reaction of reducing sugars (e.g., glucosone and 3-deoxyglucosone) with amino groups. The reduction in total and reducing sugars reflects the occurrence of Maillard reaction due to effect of acid concentration during hydrolysis, not only on chitin but also on protein content and therefore on free AA content.

Color parameters are shown in Table 2. Lightness, L *, decreased as the acid concentration increased; however, at ratios 1:5 and 1:3 there was no significant difference between 1N and 3N. In general, higher acid concentrations led to darker solutions. Parameter a* showed the highest variability among all the values; the ratio was most determinant for this hue. The sensitivity of b* was high with increases in both variables, acid concentration and CP:A ratio.

TABLE 2
Color parameters (L*, a*, and b*) in cricket powder hydrolysates.

| | Parameter | | | |
|---|---|---|---|---|
| | HCl | | | |
| Ratio | Concen- | | | |
| (CP:A) | tration | L* | a* | b* |
| 1:10 | 1N | 61.32 ± 1.92^{Aa} | 14.98 ± 2.80^{Bc} | 44.50 ± 1.70^{Aa} |
| 1:5 | | 54.57 ± 2.82^{Ab} | 15.93 ± 1.03^{Cb} | 41.77 ± 2.48^{Aa} |
| 1:3 | | 48.00 ± 1.90^{Ac} | 25.57 ± 1.74^{Aa} | 36.32 ± 3.08^{Ab} |
| 1:10 | 3N | 43.77 ± 1.27^{Ba} | 18.40 ± 0.82^{Ab} | 25.00 ± 1.75^{Ba} |
| 1:5 | | 33.90 ± 1.58^{Bb} | 26.38 ± 0.63^{Aa} | 16.45 ± 2.12^{Bb} |
| 1:3 | | 32.27 ± 1.30^{Bb} | 18.70 ± 0.56^{Bb} | 8.63 ± 0.51^{Bc} |
| 1:10 | 6N | 40.52 ± 2.96^{Ba} | 5.58 ± 1.86^{Cc} | 11.95 ± 1.41^{Ca} |
| 1:5 | | 33.23 ± 3.14^{Bb} | 21.22 ± 3.37^{Ba} | 10.28 ± 2.36^{Ca} |
| 1:3 | | 27.72 ± 0.56^{Cc} | 13.33 ± 1.64^{Cb} | 3.65 ± 0.83^{Cb} |

^{ABC}Different upper-case letters denote significant differences (p < 0.05) between acid concentration (1N, 3N, and 6N) at the same CP:A ratio.^{abc}. Different lower-case letters denote significant differences (p < 0.05) between CP:A ratios (1:10, 1:5, and 1:3) at the same acid concentration.

### Example 16. Salt Content by Mohr Method

380 The salt content in the hydrolysates can be determined by titration; or it can be estimated by stochiometric calculations based on the amount of HCl and NaOH used. Based on the calculated amounts of NaCl, ranging from 3% to 16%, it is reasonable to infer that the trends shown in total solids and ash content were influenced by the severity of treatment. (Data not shown, but provided in priority application 63/702,680.)

Commercial brands of soy sauce, most of which are fermented (koikuchi, usukuchi, tamari, saishikomi, and shiro), normally have a salt content between 7% and 19%. The role of salt is vital for soy sauces in general, since salt not only enhances the profile of flavor compounds in the food matrix, but it also serves multiple functions such as preservative, modulator of water activities, and structural purposes.

### Example 17. Viscosity

The viscosities of samples of nine types of hydrolysates were measured at different spindle speeds: 25, 50, 75, and 100 rpm. (Data not shown, but provided in priority application 63/702,680.) In general, the behavior of the solutions under shear force depended on protein content. However, in the case of hydrolysates from acidic treatments that had been filtered to remove insoluble particles, the viscosity showed only minor changes across different protein levels, presumably because both protein and (chitin) had been disrupted into AA's and smaller sugars. The variations in viscosity were generally small; however, significant differences were seen for samples treated at 6 N at ratios 1:3 and 1:5, 1.86 0.04 cp and 1.60 0.05 cp, respectively.

The viscosity of the hydrolysates is expected to have only a small effect on consumer perception.

### Example 18. Free Amino Acids Determination

Proteins in cricket powder suspensions treated with acid and high temperature undergo cleavage of peptide bonds to release amino acids. As the ratio of cricket powder to acid increased (from 1:10 to 1:3), the amino acid concentration generally increased (Table 3). This trend was seen for all amino acids. As the acid concentration increased (from 1 N to 6 N), there was a general trend of increasing amino acid concentration for most amino acids. The highest total amino acid concentration (69.01±8.82 mg/mL) was observed at a 1:3 ratio with 6 N acid, while the lowest total amino acid concentration (7.38±0.48 mg/mL) was observed at a 1:10 ratio with 1 N acid.

TABLE 3
Free amino acids content of cricket powder hydrolysates (mg/mL).

| Amino | 1N | | | 3N | | | 6N | | |
|---|---|---|---|---|---|---|---|---|---|
| Acids | 1:10 | 1:5 | 1:3 | 1:10 | 1:5 | 1:3 | 1:10 | 1:5 | 1:3 |
| Aspx | 2.38 ± | 1.73 ± | 3.15 ± | 1.74 ± | 3.42 ± | 6.27 ± | 2.82 ± | 5.72 ± | 8.26 ± |
| | 0.19^{Ba} | 0.10^{BAc} | 0.85^{Ab} | 0.13^{Ca} | 0.18^{Bb} | 0.30^{Aa} | 0.82^{Ca} | 0.55^{Ba} | 1.15^{Aa} |
| Glx | 0.55 ± | 0.55 ± | 0.51 ± | 1.53 ± | 2.95 ± | 5.94 ± | 3.66 ± | 7.19 ± | 10.51 ± |
| | 0.10^{Ab} | 0.04^{Ac} | 0.01^{Ac} | 0.04^{Cb} | 0.12^{Bb} | 0.61^{Ab} | 0.93^{Ba} | 0.23^{Aa} | 2.11^{Aa} |
| Ser | 0.34 ± | 0.43 ± | 0.36 ± | 0.72 ± | 1.59 ± | 2.84 ± | 2.03 ± | 3.90 ± | 5.26 ± |
| | 0.05^{Ab} | 0.01^{Ac} | 0.07^{Ac} | 0.05^{Cb} | 0.32^{Bb} | 0.46^{Ab} | 0.49^{Ba} | 0.26^{Aa} | 0.82^{Aa} |
| Gly | 0.48 ± | 0.65 ± | 0.65 ± | 0.89 ± | 1.57 ± | 3.09 ± | 1.33 ± | 2.61 ± | 3.84 ± |
| | 0.03^{Bb} | 0.01^{Ac} | 0.01^{Aab} | 0.20^{Bb} | 0.06^{Bb} | 0.64^{Aa} | 0.31^{Ca} | 0.11^{Ba} | 0.76^{Aa} |
| His | 0.12 ± | 0.13 ± | 0.19 ± | 0.11 ± | 0.18 ± | 0.31 ± | 0.40 ± | 0.62 ± | 0.87 ± |
| | 0.03^{Ab} | 0.01^{Ab} | 0.09^{Ab} | 0.02^{Bb} | 0.08^{ABb} | 0.10^{Aab} | 0.19^{Aa} | 0.25^{Aa} | 0.38^{Aa} |
| Arg | 0.92 ± | 1.17 ± | 1.07 ± | 0.75 ± | 1.94 ± | 3.34 ± | 1.80 ± | 3.42 ± | 5.05 ± |
| | 0.05^{Aa} | 0.19^{Ab} | 0.12^{Ac} | 0.38^{Ca} | 0.25^{Bb} | 0.20^{Ab} | 0.63^{Ca} | 0.53^{Ba} | 0.22^{Aa} |
| Thr | 0.15 ± | 0.24 ± | 0.12 ± | 0.36 ± | 0.53 ± | 1.21 ± | 0.93 ± | 1.83 ± | 2.61 ± |
| | 0.08^{Ab} | 0.17^{Ab} | 0.04^{Ac} | 0.13^{Bb} | 0.06^{Bb} | 0.24^{Ab} | 0.31^{Ba} | 0.18^{Aa} | 0.46^{Aa} |
| Ala | 0.54 ± | 1.06 ± | 0.96 ± | 1.66 ± | 3.08 ± | 5.00 ± | 2.52 ± | 4.83 ± | 6.92 ± |
| | 0.39^{Ab} | 0.04^{Ac} | 0.01^{Ac} | 0.10^{Cab} | 0.52^{Bb} | 0.40^{Ab} | 1.05^{Ca} | 0.66^{Ba} | 0.62^{Aa} |
| Pro | 0.22 ± | 0.37 ± | 0.26 ± | 0.56 ± | 1.39 ± | 2.23 ± | 1.50 ± | 2.67 ± | 3.97 ± |
| | 0.01^{Bb} | 0.05^{Ac} | 0.01^{Bc} | 0.13^{Cb} | 0.41^{Bb} | 0.20^{Ab} | 0.50^{Ba} | 0.49^{ABa} | 0.67^{Aa} |
| Tyr | 0.23 ± | 0.36 ± | 0.13 ± | 0.54 ± | 0.93 ± | 1.23 ± | 1.25 ± | 1.24 ± | 1.51 ± |
| | 0.16^{Ab} | 0.29^{Ab} | 0.02^{Ab} | 0.17^{Bb} | 0.28^{ABab} | 0.31^{Aa} | 0.16^{Aa} | 0.10^{Aa} | 0.36^{Aa} |
| Val | 0.43 ± | 0.27 ± | 0.19 ± | 0.52 ± | 1.03 ± | 1.78 ± | 1.45 ± | 2.83 ± | 4.02 ± |
| | 0.40^{Ab} | 0.10^{Ac} | 0.02^{Ac} | 0.06^{Bb} | 0.34^{Bb} | 0.36^{Ab} | 0.36^{Ba} | 0.06^{ABa} | 0.88^{Aa} |
| Met | 0.07 ± | 0.12 ± | 0.15 ± | 0.19 ± | 0.28 ± | 0.57 ± | 0.41 ± | 0.88 ± | 1.27 ± |
| | 0.02^{Ab} | 0.07^{Ab} | 0.03^{Ac} | 0.03^{Bb} | 0.05^{Bb} | 0.13^{Ab} | 0.11^{Ba} | 0.11^{Aa} | 0.25^{Aa} |
| Cys | 0.15 ± | 0.27 ± | 0.26 ± | 0.08 ± | 0.85 ± | 1.52 ± | 0.24 ± | 0.81 ± | 0.30 ± |
| | 0.09^{Aa} | 0.06^{Aa} | 0.03^{Aa} | 0.04^{Aa} | 0.24^{Aa} | 0.98^{Aa} | 0.04^{Aa} | 0.68^{Aa} | 0.06^{Aa} |
| Ile | 0.08 ± | 0.32 ± | 0.16 ± | 0.22 ± | 0.61 ± | 0.70 ± | 0.87 ± | 2.16 ± | 2.37 ± |
| | 0.05^{Ab} | 0.21^{Ab} | 0.01^{Ab} | 0.13^{Ab} | 0.34^{Ab} | 0.12^{Ab} | 0.31^{Aa} | 0.87^{Aa} | 0.57^{Aa} |
| Leu | 0.29 ± | 0.66 ± | 0.30 ± | 0.91 ± | 1.58 ± | 2.79 ± | 2.04 ± | 3.57 ± | 5.74 ± |
| | 0.07^{Ab} | 0.33^{Ab} | 0.01^{Ac} | 0.17^{Cb} | 0.25^{Bb} | 0.20^{Ab} | 0.62^{Ba} | 0.53^{Ba} | 0.77^{Aa} |
| Phe | 0.13 ± | 0.31 ± | 0.27 ± | 0.37 ± | 0.85 ± | 1.51 ± | 0.68 ± | 1.79 ± | 1.99 ± |
| | 0.05^{Bb} | 0.09^{Aa} | 0.02^{ABc} | 0.17^{Bb} | 0.35^{Ba} | 0.13^{Ab} | 0.06^{Aa} | 1.10^{Aa} | 0.27^{Aa} |
| Lys | 0.29 ± | 0.40 ± | 0.34 ± | 0.75 ± | 1.26 ± | 2.34 ± | 1.40 ± | 3.04 ± | 4.51 ± |
| | 0.01^{Cb} | 0.01^{Ac} | 0.03^{Bc} | 0.03^{Cab} | 0.07^{Bb} | 0.03^{Ab} | 0.72^{Ca} | 0.47^{Ba} | 0.29^{Aa} |
| Total | 7.38 ± | 9.03 ± | 9.06 ± | 11.92 ± | 24.04 ± | 42.67 ± | 25.34 ± | 49.11 ± | 69.01 |
| | 0.48^{Bc} | 0.90^{Ac} | 0.96^{Ac} | 0.63^{Cb} | 3.30^{Bb} | 2.27^{Ab} | 7.36^{Ca} | 5.42^{Ba} | 8.82^{Aa} |

Mean values ± Std. Deviation (n = 3).
^{ABC}Different upper-case letters denote significant differences (p < 0.05) between CP:A ratios (1:10, 1:5, and 1:3) at a given acid concentration.
^{abc}Different lower-case letters denote significant differences (p < 0.05) between acid concentrations (1N, 3N, and 6N) at a given CP:A ratio.

Concentrations of Aspx and Glx increased significantly with increased CP:A ratios at all acid concentrations, except for 1 N. Serine (Ser) showed a similar increase in concentration at 3 N acid; however, at 6 N acid there was no variation between CP:A ratios 1:5 and 1:3. Glutamic acid (Glx) and aspartic acid (AspX) had the highest concentrations among all amino acids across all conditions. Methionine (Met) and cysteine (Cys) generally had the lowest concentrations among all amino acids across all conditions. The largest increase in AA concentration as the acid concentration increased from 1 N to 6 N was observed for Glx at a 1:3 ratio, going from 0.51±0.01 mg/mL to 10.51±2.11 mg/mL. The smallest increase in AA concentration from 1 N to 6 N acid was observed for Cys at a 1:3 ratio, going from 0.26±0.03 mg/mL to 0.30±0.06 mg/mL. Cysteine and threonine (Thr) are expected to undergo a dehydration reaction, possibly yielding pyruvic acid. Concentrations of the essential amino acids Histidine (His), isoleucine (Ile), leucine (Leu), lysine (Lys), methionine (Met), phenylalanine (Phe), threonine (Thr), and valine (Val) increased both with increasing acid concentration and with a decreasing ratio of cricket powder to acid. Concentrations of the non-essential amino acids Alanine (Ala), Arginine (Arg), Aspx, Cys, Glx, Glycine (Gly), Proline (Pro), Ser, and Tyrosine (Tyr) followed a similar trend, increasing with increasing acid concentration, and increasing with a decreasing ratio of cricket powder to acid. Less variation was seen across conditions for the amino acids phenylalanine, tyrosine, and histidine, which may have greater resistance to hydrolysis from their aromatic rings. Low concentrations observed for valine and isoleucine may be the result of peptide bonds that are harder to split due to their hydrophobic moieties.

Chitin is present in the cricket powder, of course. It is possible that depolymerization and deacetylation of chitin, along with the release of amino acids could induce the formation of Maillard Reaction products (MRP).

### Example 19. Efficacy of Amino Acid Recovery from Cricket Protein Via Acid Hydrolysis

Amino acid recovery reflects the efficiency of individual reactions in extracting AAs from the protein source. However, the observed percentages may not reflect the proportion of the AA's that were subsequently degraded or consumed as reactants in further reactions with other components such as chitin or fats. The greatest percentage of recovery was observed for samples treated with 6 N acid, and the lowest recovery was seen in samples treated with 1 N HCl (Table 4). At a given concentration, increased AA recovery levels generally followed decreased solid:liquid ratios.

TABLE 4
Total amino acids content per gram of unhydrolyzed cricket
powder, and percentages of recovery in hydrolysates.

| CP:A | Acid | | AA recovered from CP |
|---|---|---|---|
| Ratio | Concentration | TAA^{§} (mg/g CP) | after Hydrolysis (%) |
| 1:10 | 1N | 73.75 ± 4.82 | 14.06 ± 0.92 |
| 1:5 | | 45.14 ± 4.50 | 8.61 ± 0.86 |
| 1:3 | | 27.44 ± 2.92 | 5.23 ± 0.56 |
| 1:10 | 3N | 119.16 ± 6.31 | 22.72 ± 1.20 |
| 1:5 | | 120.22 ± 16.51 | 22.92 ± 3.15 |
| 1:3 | | 129.30 ± 6.88 | 24.66 ± 1.31 |
| 1:10 | 6N | 253.40 ± 73.56 | 48.32 ± 14.03 |
| 1:5 | | 245.56 ± 27.12 | 46.82 ± 5.17 |
| 1:3 | | 209.11 ± 26.73 | 39.87 ± 5.10 |

^{§}TAA, total amino acids, denotes the sum of 17 individual AAs.

### Example 20. Organic Acids in Cricket Hydrolysates

The quantification of organic acids in cricket powder hydrolysate revealed significant differences across different hydrochloric acid concentrations and CP:A ratios (Table 5). Oxalic, formic, and propionic acids increased with increasing acidic concentrations, reaching peaks at 6 N for each ratio, with the highest levels at the 1:3 ratio, 13.59±0.26, 25.14±3.09, and 24.74±4.38 mg/g, respectively. Lactic acid was found in the highest concentration at 3 N for a 1:3 ratio, and decreased in concentration as the CP:A ratio increased. A comparable trend was identified for acetic acid, with a highest concentration at a 1:3 ratio for 3 N. The concentration of orotic acid was highest at a 1:3 ratio for 6 N and 3 N (with no significant differences between the two), a concentration that decreased as the ratio increased. Two organic acids showed peaks at 3 N: succinic acid at a 1:3 ratio, 13.04±0.99 mg/g; and uric acid at a 1:5 ratio, 1.44±0.12 mg/g. Fumaric acid had a maximum concentration at 1 N for a 1:3 and 1:5 ratio, and its concentration decreased with an increasing CP:A ratio. Butyric acid similarly had a highest concentration at 1 N for a 1:3 ratio, without significant differences for different acid concentrations.

TABLE 5
Organic acids content of cricket powder hydrolysates (mg/g of hydrolysate).

| Organic | 1N | | | 3N | | | 6N | | |
|---|---|---|---|---|---|---|---|---|---|
| Acid | 1:3 | 1:5 | 1:10 | 1:3 | 1:5 | 1:10 | 1:3 | 1:5 | 1:10 |
| Oxalic | 2.72 ± | 2.53 ± | 3.29 ± | 11.85 ± | 9.5 ± | 1.51 ± | 13.59 ± | 9.31 ± | 5.27 ± |
| Acid | 0.05^{Ac} | 0.16^{Ab} | 1.49^{Ab} | 0.12^{Ab} | 0.19^{Ba} | 0.07^{Cab} | 0.26^{Aa} | 0.17^{Ba} | 0.86^{Ca} |
| | | | | | | | | | 1 |
| Formic | 19.88 ± | 14.54 ± | 9.88 ± | 21.67 ± | 15.85 ± | 10.17 ± | 25.14 ± | 21.32 ± | 3.42 ± |
| Acid | 2.31^{Aa} | 0.32^{Bb} | 4.35^{Ba} | 0.19^{Aa} | 1.82^{Bb} | 0.15^{Ca} | 3.09^{Aa} | 0.6^{Ba} | 0.79^{Ca} |
| Lactic | 8.99 ± | 9.71 ± | 4.77 ± | 12.05 ± | 7.96 ± | 5.67 ± | 9.07 ± | 6.54 ± | 4.46 ± |
| Acid | 0.29^{Ab} | 0.8^{Aa} | 2.37^{Ba} | 0.59^{Aa} | 2.48^{Ba} | 0.34^{Ba} | 1.65^{Ab} | 1.37^{ABa} | 1.14^{Ba} |
| Acetic | 10.06 ± | 12.24 ± | 5.53 ± | 12.04 ± | 8.74 ± | 5.45 ± | 7.57 ± | 5.06 ± | 3.39 ± |
| Acid | 0.23^{Aa} | 1.07^{Aa} | 2.58^{Ba} | 3.5^{Aa} | 3.21^{ABab} | 0.71^{Ba} | 1.83^{Ba} | 1.14^{ABb} | 0.97^{Ba} |
| Orotic | 0.29 ± | 0.25 ± | 0.08 ± | 0.38 ± | 0.34 ± | 0.17 ± | 0.4 ± | 0.23 ± | 0.16 ± |
| Acid | 0.02^{Ab} | 0.02^{Ab} | 0.07^{Ba} | 0.02^{Aa} | 0.05^{Aa} | 0.01^{Ba} | 0.04^{Aa} | 0.01^{Bb} | 0.02^{Ca} |
| Succinic | 11.59 ± | 12.9 ± | 7.8 ± | 13.04 ± | 3.88 ± | 4.6 ± | 7.68 ± | 3.73 ± | 2.15 ± |
| Acid | 0.46^{Aa} | 0.77^{Aa} | 2.34^{Ba} | 0.99^{Aa} | 3.31^{Bb} | 0.42^{Bab} | 6.74^{Aa} | 3.85^{Ab} | 0.6^{Ab} |
| Uric Acid | 0.7 ± | 0.62 ± | 0.75 ± | 1.06 ± | 1.44 ± | 0.96 ± | 0.9 ± | 0.41 ± | 0.8 ± |
| | 0.01^{Ac} | 0.04^{ABb} | 0.08^{Bb} | 0.02^{Ba} | 0.12^{Aa} | 0.03^{Ca} | 0.07^{Ab} | 0.02^{Bc} | 0.03^{Cb} |
| Fumaric | 0.07 ± | 0.07 ± | 0.03 ± | 0.05 ± | 0.03 ± | 0.02 ± | 0.06 ± | 0.01 ± | 0.02 ± |
| Acid | 0.002^{Aa} | 0.003^{Aa} | 0.01^{Ba} | 0.003^{Aa} | 0.01^{Bb} | 0.003^{Ba} | 0.03^{Aa} | 0.01^{Ab} | 0.01^{Aa} |
| Propionic | 13.93 ± | 15.49 ± | 13.4 ± | 23.97 ± | 22.09 ± | 14.53 ± | 24.74 ± | 17.44 ± | 16.88 ± |
| Acid | 0.55^{Ab} | 0.58^{Ab} | 3.3^{Aa} | 0.59^{Aa} | 3.57^{Aa} | 1.36^{Ba} | 4.38^{Aa} | 2.56^{Bab} | 2.42^{Ba} |
| Butyric | 31.27 ± | 26.65 ± | 9.52 ± | 25.97 ± | 21.29 ± | 23.1 ± | 19.86 ± | 12.25 ± | 11.95 ± |
| Acid | 1.4^{Aa} | 3.29^{Aa} | 5.71^{Ba} | 1.77^{Aa} | 11.17^{Aa} | 3.76^{Aa} | 11.54^{Aa} | 5.3^{Aa} | 8.29^{Aa} |

Mean values ± Std. Deviation (n = 3).
^{ABC}Different upper-case letters denote significant differences (p < 0.05) between ratios (1:10, 1:5, and 1:3) at a given acid concentration.
^{abc}Different lower-case letters denote significant differences (p < 0.05) between acid concentration (1N, 3N, and 6N) at a given CP:A ratio.

Interestingly, although fumaric acid was the most abundant organic acid in untreated cricket flour, it was far less abundant in the hydrolysates, possibly due to esterification to fumarates at low pH. Organic acids such as acetic, propionic, butyric, and succinic can also potentially be generated by the degradation of sugars.

Organic acids play an important role in the perception of taste in foods, beyond simple “sourness.” For example, oxalic acid, lactic acid, fumaric acid, and acetic acid have all been described as astringent (gentle), while succinic acid has been reported to impart a light umami flavor. Factors such as pH, interaction with other flavoring properties (sweetness, saltiness, or bitterness), concentrations of other flavors, and complexity of flavor compounds can affect the sour, astringent, or light umami perceptions of organic acids.

### Example 21. Volatile Compounds in Cricket Hydrolysates

GC-MS analysis identified volatile compounds by their RI values, mass spectral data, and comparisons of retention time versus standards. Where a pertinent standard was unavailable, compounds were provisionally identified and compared with a mass spectral database library and RI values. Thirty-six compounds were identified in this manner, of which thirteen were quantified by comparison to standard solutions. (Data not shown, but provided in priority application 63/702,680.) Heating cricket protein suspensions with hydrochloric acid can hydrolyze the peptide bonds, releasing amino acids. More-or-less simultaneously the chitin structure also hydrolyzes, leaving smaller sugars in in the hydrolysates.

Compounds such as aldehydes, ketones, alcohols, esters, acids, furans, alkenes, alkanes, pyrazines, pyrazoles, and lactones can be formed through diverse pathways that for instance might involve lipid oxidation, sugar degradation, Maillard reaction, Strecker degradation, and thermal degradation of amino acids.

Aldehydes such as heptanal, nonanal, and decanal were possibly produced by lipid oxidation. The formation of n-alkanals and some alkenals may have resulted from the oxidation of unsaturated fatty acids, which initially produces hydroperoxides, which then subsequently decompose to aldehydes, ketones, and alcohols. Heptanal reached its highest concentration of 219.57±59.42 μg/L at 6 N with a ratio of 1:3; and its lowest concentration, 87.08±17.91 μg/L, at 1N at a ratio of 1:5. Heptanal has been described as having a citrus, fat, and green aroma. Some Strecker aldehydes such as 3-methyl butanal, benzaldehyde, and phenylacetaldehyde were identified. The 3-methyl butanal formed from leucine, while benzaldehyde and phenylacetaldehyde were produced by degradation of phenylalanine. The 3-methyl butanal has an apple-like aroma. Benzaldehyde is commonly referred to as having a malty, almond-like, or roasted aroma. Phenylacetaldehyde has been described as honey-like, nutty, and pungent. The maximum concentration of benzaldehyde in the hydrolysates was seen at a 1:3 CP:A ratio at all acid concentrations, and that concentration correlated with decreasing proportions of cricket powder. Phenylacetaldehyde showed higher concentrations with increasing concentrations of hydrochloric acid. Among the ketones identified in the hydrolysates were 2-heptanone; 3-heptanone; 2,6-dimethyl-1-phenylethanone (acetophenone); and 2,6-dimethyl-2,5-heptadien-4-one (phorone). The maximum values quantified for the ketones were 29.41±2.33 μg/L for 2-heptanone at a 1:10 ratio in 1 N, and 15.29±2.27 μg/L for acetophenone at a 1:3 ratio in samples hydrolyzed with HCl 6 N. Both of these ketones can be produced as oxidized volatiles via lipid oxidation. 2-heptanone has an aroma reminiscent of blue cheese, spicy, and green; while acetophenone has been described as having a meaty and musty aroma.

Furans were also found in the hydrolysates: ethanone l-(2-furanyl)-; 2-acetyl-5-methylfuran; 5-methyl-2-furancarboxaldehyde; and 1-propanone-(5-methyl-2-furanyl). The furans presumably were derived primarily from the thermal degradation of sugars, in the presence or absence of amino acids. The maximum concentration for ethanone 1-(2-furanyl)—was found at the highest proportion of cricket powder and the highest concentration of acid. For the remaining conditions, the difference between ratios was attenuated, with only a significant increase in 1:3 at 3 N compared with other ratios, and no significant differences between ratios at I N. The aroma descriptors for furans range from caramel-like to meaty or a burnt odor.

Pyrazines are another group of volatile compounds that can be generated by the reactions of sugars with amino acids. Eight pyrazines were identified in these treatments. Strecker degradation is one pathway to pyrazines, involving the condensation of amino acids with a-dicarbonyl groups. Pyrazine, 2,5-dimethyl reached its highest concentration at 6 N, with the highest ratio showing a significant decrease. Some common odor descriptors used for pyrazine are roast beef or toasted nuts. Two phenolic compounds were found in the volatiles analysis. Phenols and methoxyphenols could be formed by the pyrolysis of polysaccharides, and they have been reported as important contributors to the smoky flavor in soy sauce. The concentrations of 2-methyl phenol and 2-methoxy phenol (guaiacol) reached their highest concentrations at a 1:3 ratio and 3 N and 6 N, respectively; however, 2-methyl phenol did not show significant differences at 6 N at the same ratio. Both compounds have been identified in acid-hydrolyzed soy sauce. Another aromatic compound identified and quantified was 2-(3H)-Furanone, dihydro-5-pentyl-(7-nonalactone), whose odor is commonly perceived as coconut-like. The maximum concentration was found at 6 N at the lowest CP:A ratio. The contribution of amino acids content to the volatiles profile of the hydrolysates presumably depends in part on the types of amino acids released by the heat and acid treatment. For instance, the presence of sulfur-containing AAs can result in the formation of a meat-like aroma upon reaction with sugars; however, in this study, sulfur-containing volatile compounds were not identified. AAs such as leucine, isoleucine, or valine might produce caramel or cereal-like aromas.

### Discussion

The overall aroma composition of the acid-hydrolyzed cricket protein comprised a complex combination of odorants generated by reactions such as lipid oxidation, sugar degradation, Strecker degradation, thermal degradation of amino acids, and Maillard reactions. The most abundant volatile compounds were 1-(2-furanyl)-ethenone; benzaldehyde; 5-methyl-2-furancarboxaldehyde; 2-acetyl-5-methylfuran; and phenylacetaldehyde. Organic acids having important roles in flavors, such as succinic acid and lactic acid, were found in the hydrolysates at all reaction conditions. Total and reducing sugar analysis suggests that at higher levels of acid hydrolysis the sugars are used in greater proportions in forming MRPs. The hydrolysates prepared with HCl at 6 N had a significantly richer aromatic profile as compared to unhydrolyzed protein. Under specific conditions, they can retain from 40% to 50% of total amino acids in soluble form from the unhydrolyzed cricket powder. Although unmodified cricket meal has only a limited aroma profile, many flavor substances were produced by the acid hydrolysis, making the acid hydrolysates useful in a variety of baked goods, seasonings, and savory foods.

### Example 22. Aroma Profile for Hydrolyzed Cricket Protein as Evaluated by Consumer Focus Groups and Questionnaires

Consumer perception of the flavors and aromas for a novel food product is important. We evaluated consumer perception both through focus groups and with check-all-that-apply questionnaires. Details of how the consumer perception data were gathered and analyzed may be found in priority application 63/702,680. Presented here are an overall summary of the consumer perception study and its principal conclusions.

Samples for these studies were prepared by mixing dried cricket powder with hydrochloric acid (6 N, 3 N, or 1 N) at different ratios of cricket powder to acid (1:10, 1:5, or 1:3, w/v). The reaction temperature was maintained at 95 2° C. for 8 h. The samples were then cooled to room temperature and neutralized with sodium hydroxide (6 N, 3 N, or 1 N, respectively) to pH 4.5±0.5. After neutralization, the samples were centrifuged at 5000 rpm and vacuum-filtered through a Whatman filter #1. After filtration, the hydrolysates were stored in 5 ml glass vials with phenolic caps under refrigeration (4° C.) until used.

Terms such as “Salty,” “Savory,” “Seasoning-like,” and “Smoky,” which are frequently-used sensory descriptions for soy sauce were also the most frequent descriptors given by focus group panelists for the novel cricket powder hydrolysates.

The novel cricket powder hydrolysates have high nutritional quality, particularly their overall protein levels and essential amino acids. Nevertheless, the consumption of edible insects faces significant cultural barriers in Western society. Sensory properties can help gain consumer acceptance. Different processing methods (e.g., roasting, boiling, and frying, etc.) may be appropriate for different insects, particularly in light of the varying protein content, fatty acid profile, and chitin content across species. Our studies found that heating aqueous suspensions of cricket powder in the presence of reducing sugars led to an increase in Maillard reaction products, and an improvement in water holding capacity, solubility, and thermal stability of the freeze-dried solid fraction. However, the low levels of free amino acids limited the development of flavors to enhance the sensory profile.

We found that acid hydrolysis substantially improves the sensory profile of the reaction products, for example by increasing interactions between amino acids and sugars following the breakdown of proteins and chitin. Various compounds such as aldehydes, ketones, alcohols, esters, acids, furans, alkenes, alkanes, pyrazines, pyrazoles, and lactones were produced thereby. These reactions proceeded through various pathways such as lipid oxidation, sugar degradation, Maillard reaction, Strecker degradation, and thermal degradation of amino acids. The hydrolysed product not only had a much richer aromatic profile than the unhydrolyzed starting material, but suitable reaction conditions can hydrolyze up to 40% to 50%% of the total protein from the unhydrolyzed cricket powder into soluble amino acids. This allows a complex product to be produced in a relatively short time, with relatively simple equipment, having a range of aroma compounds comparable to those more typically resulting from longer and more complex fermentation processes (such as those typically used in making soy sauce).

Edible insects represent a sustainable alternative food source. They consume less resources as compared to conventional livestock. They typically have desirable nutritional qualities: protein, lipids, vitamins, and minerals. Although entomophagy is practiced by approximately 2 billion people around the world, consumer acceptance of food products containing edible insects has been limited in western countries. There is an unfilled need for food products derived from insects that mimic more familiar food sources. Developing novel, savory, insect-derived foods can help increase the familiarity and acceptance of insect-based products.

Thermal processing of cricket protein in aqueous solution at 70° C. or 90° C., with or without the presence of reducing sugars, does not significantly improve the volatiles profile. We have discovered, however, that acid hydrolysis of cricket protein provides a straightforward, practical, and rapid way to produce desirable aroma compounds. Cricket protein hydrolysates possess a profile of volatiles and organic acids that render them well-suited as flavoring agents. As one example, they may be used as a replacement for conventional soy sauce.

Consumer preference for soy-sauce like products in accordance with the present invention may be enhanced by pre-hydrolysis treatment steps, for example the partial or complete removal of the lipid fraction from the cricket meal, to limit the formation of compounds from lipid oxidation that can produce rancid or off-notes. Defatting can be achieved through methods otherwise known in the art, for example by fractionation with solvents such as ethanol, hexane, acetone, or other GRAS-listed solvents. Another optional step would be to remove chitin to improve the final characteristics of the hydrolysate by increasing the concentration of taste-active amino acids and small peptides. This step may also result in better conditions for a subsequent controlled Maillard reaction with addition of selected reducing sugars (glucose, fructose, or xylose) to produce desirable flavor notes. If desired, chitin could be removed by acid-base treatment, or enzymatic treatment, or microbial fermentation, with EDTA, or with deep eutectic solvents.

### Example 23

Prototype embodiments to date have used house cricket (Acheta domesticus) protein as the starting material. The invention may also be practiced with other edible insect substrates, for example: other cricket species such as Brachytrupes membranaceus, Gryllus similis, Gryllus bimaculatus, and Gryllotalpa orientali; Yellow mealworms, Tenebrio molitor; Locusta migratoria (50% protein); Silkworm pupae, Bombyx mori (21% protein) or Samia cynthia ricini; Black soldier fly, Hermetia illucens; lesser mealworm larvae, Alphitobius diaperinus (45-50% protein); Superworm larvae, Zophobas morio; Honeybee, Apis mellifera; Mopane caterpillar, Imbrasia belina; African palm weevil, Rhynchoporus phoenicis; various Beetles, Coleoptera.

### Example 24

Optional treatment or pre-treatment steps may be employed to enhance the overall process, or to modify the resulting product. Such optional steps may include, for example, defatting or a controlled Maillard reaction. Pre-hydrolysis steps include partial or complete removal of the lipid fraction from the cricket meal to limit the formation of lipid oxidation products that can cause rancid or off-notes in the hydrolysate. Defatting can be performed with ethanol, hexane, acetone, or other GRAS-listed solvents. Optionally, following acid hydrolysis, desirable flavor notes can be imparted with a controlled Maillard reaction with the addition of one or more reducing sugars, e.g., glucose, fructose, or xylose.

The complete disclosures of all references cited herein are hereby incorporated by reference in their entirety. Also incorporated by reference is the complete disclosure of the priority application, U.S. provisional patent application Ser. No. 63/702,680, filed Oct. 3, 2024. Also incorporated by reference is the complete disclosure of E. Villasmil, “Exploring Cricket Protein Processing: Aroma Generation, Physicochemical Properties, and Sensory Characterization,” LSU Doctoral Dissertation (2024). In the event of an otherwise irreconcilable conflict, however, the present specification shall control over material incorporated by reference.

What is claimed:

1. A method for preparing an edible composition from insect protein, comprising the steps of:
(a) hydrolyzing the insect protein by reacting the protein with water at an acid concentration of 1 N or greater, at a temperature 85° C. or greater, for a time 2 hours or longer; and
(b) cooling the reaction mixture to a temperature of 40° C. or lower, and raising the pH of the reaction mixture to a level acceptable for an edible composition.

2. The method of claim 1, additionally comprising the step of filtering or clarifying the reaction mixture to reduce the level of suspended solids in the mixture.

3. The method of claim 1, additionally comprising the step of partially or completely removing lipids from the insect protein prior to said hydrolyzing step.

4. The method of claim 1, additionally comprising the step of partially or completely removing chitin from the insect protein.

5. The method of claim 1, additionally comprising the step, following said hydrolyzing step, of adding one or more reducing sugars to the reaction mixture and allowing Maillard reaction to occur with the reaction mixture with the reducing sugars.

6. The method of claim 1, wherein the insect protein comprises protein from one or more insects selected from the group consisting of: crickets, Gryllidae; yellow mealworms, Tenebrio molitor; locust Locusta migratoria; silkworm pupae or larvae, Bombyx mori or Samia cynthia ricini; black soldier fly, Hermetia illucens; lesser mealworm larvae, Alphitobius diaperinus; superworm larvae, Zophobas morio; honeybee, Apis mellifera; mopane caterpillar, Gonimbrasia belina; African palm weevil, Rhynchoporus phoenicis; and beetles, Coleoptera.

7. The method of claim 1, wherein the insect protein comprises protein from house crickets, Acheta domesticus.

8. The method of claim 1, wherein said hydrolyzing step comprises reacting the insect protein with water and acid, at a temperature 90° C.-100° C., for a time 4-12 hours.

9. The method of claim 1, wherein said hydrolyzing step comprises reacting the insect protein with water and acid, at a temperature about 95° C., for a time about 8 hours.

10. The method of claim 1, wherein the composition is a soy sauce-like condiment.
